(19) United States
(12) Patent Application Publication
(10) Pub. No.: US 2020/0263715 A1
(43) Pub. Date: Aug. 20, 2020

(54) FASTENER FOR SWIMMING POOL STEP ASSEMBLY, AND METHOD OF ASSEMBLY

(71) Applicant: Hydra Pools, Inc., Sweetwater, TN (US)

(72) Inventor: Laurence A. Nelson, Knoxville, TN (US)

(21) Appl. No.: 16/796,004

(22) Filed: Feb. 20, 2020

Related U.S. Application Data
(60) Provisional application No. 62/807,895, filed on Feb. 20, 2019.

(51) Int. Cl. F16B 5/02

(52) U.S. Cl. CPC F16B 5/0208; E04H 4/144; F16B 5/0258

(57) ABSTRACT

A nut retaining device, and a method of assembling a pool step assembly using the nut retaining device, the nut retaining device including a nut retainer body configured to receive a nut and prevent the nut from rotating inside the nut retainer body. and a plurality of wings extending laterally from the nut retainer body and configured to abut one or more surfaces to prevent movement of the nut retainer body.

### CROSS-REFERENCE TO RELATED APPLICATIONS

This application claims the benefit of U.S. Provisional Patent Application Ser. No. 62/807,895, filed on Feb. 20, 2019, which is incorporated herein in its entirety by reference.

### FIELD OF INVENTION

The present general inventive concept relates to a fastener system, and, more particularly, to a fastener system for a swimming pool step assembly.

### BACKGROUND

Many pool owners may discover that it would be preferable to have pool steps with which to enter and exit the pool in an easy and convenient fashion, rather than relying on a ladder. However, installing pool steps in an existing pool can be problematic for a number of reasons. For example, conventional construction techniques typically result in placing an entirely assembled set of steps in the pool, which is very cumbersome at least because of the size, weight, and general difficulty of moving such a structure. Therefore, it would be desirable to be able to add steps to a section of a pool by easily assembling the step assembly components in the pool. However, because of the overlapping nature of several of the components of the step assembly, bolting such components together during the building can also be problematic. Therefore, it would be desirable to be able to hold nuts for the bolts on the backside or underside of lower components so that a user can easily thread the bolds into the nuts without having to reach around and hold the nuts in place during assembly.

### BRIEF SUMMARY

According to various example embodiments of the present general inventive concept, a nut retainer is provided that is securable to an underlying or back panel, such as a rear surface of a swimming pool step assembly, to secure the nut in place so that a user can thread a bolt into the nut without holding the nut in place. Also provided is a pool step assembly incorporating such a nut retainer, as well as a method of assembly as described herein.

Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved by providing a nut retaining device including a nut retainer body configured to receive a nut at least partially therein, and at least one extending member extending laterally away from a longitudinal axis of the nut retainer body and configured to abut a surface to prevent movement of the nut retainer body in at least one direction.

The foregoing and/or other aspects and advantages of the present general inventive concept may also be achieved by providing a pool step system including a plurality of step members configured to have overlapping portions when assembled into steps, the overlapping portions including a plurality of upper layers and lower layers to be respectively fixed to one another, corresponding through holes formed in the upper layers and lower layers to receive a bolt to fix the upper and lower layers to one another, a plurality of raised slots formed on an underside of the lower layers proximate each of the through holes of the lower layers, a plurality of nut retaining devices each including a nut retainer body configured to receive a nut and prevent the nut from rotating inside the nut retainer body, a plurality of nuts respectively provided to the nut retaining devices, and a plurality of wings extending laterally from the nut retainer body and configured to be received in the raised slots to prevent movement of the nut retainer body, and a plurality of bolts configured to extend through the respective corresponding through holes and into the respective nuts to fix the upper and lower layers to one another. The through holes may be formed as countersinks. An inner surface of the nut retainer body that contacts the nut may be configured as a polygon. The raised slots may be integral portions of the lower layers. The raised slots may be closes at a top and at least one side thereof.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a bolt and nut retainer assembly according to an example embodiment of the present general inventive concept;

FIG. 2 illustrates a different view of the example embodiment illustrated in FIG. 1;

FIG. 3 illustrates an installation of the nut retainer illustrated in FIG. 1;

FIG. 4 illustrates the nut retainer of FIG. 1 in an installed position;

FIG. 5 illustrates an exploded cross-sectional view of components of the nut retainer assembly and two overlapping layers of a pool step assembly; and

FIGS. 6A-B respectively illustrate exploded and assembled views of a pool step assembly according to an example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, a fastener system for a swimming pool step assembly is provided. In various example embodiments, a nut retainer is provided that is lockable to an underlying panel, lip, etc. of two structural components to be bolted together, such as rear surface of a swimming pool step assembly component, by a pair of wings extending from either side of the nut retainer. The wings may be receivable within a pair of slots formed in aforementioned rear surface of the swimming pool step assembly component(s), and once so received, the retainer holds a nut in place for a bolt to be received within a recessed hole formed in the overlying panel of lip of the swimming pool step assembly. With such an arrangement, several components that will be used to construct a pool step assembly may be easily taken into the pool and assembled at the site of installation by a single person. Various example embodiments of the present general inventive concept aid the user by holding the nut in place such that the user does not have to reach around and hold the nut with one hand while screwing in the bolt with the other hand. Also, by using indentations for the screw head to produce a countersink formation, the exterior of the step assembly can be relatively smooth. Such an assembly may be installed after removing the liner from the section of the pool at which the step assembly is located. In other example embodiments the step assembly may be assembled and then an additional liner may be fitted over the step assembly. While several of the example embodiments described herein are assemblies of different layers of a swimming pool step assembly, it is understood that the present general inventive concept may be utilized in several other assemblies in which a top (or overlying) layer is secured to a bottom (or underlying) layer with a bolt, screw, or similar adhering device that is threaded to a nut. Various example embodiments of the present general inventive concept provide a structure on the bottom surface in which the nut retaining device may be received, so that the nut in the nut retaining device is held in place by one or more corresponding through openings that receive a bolt therethrough to be secured by the nut.

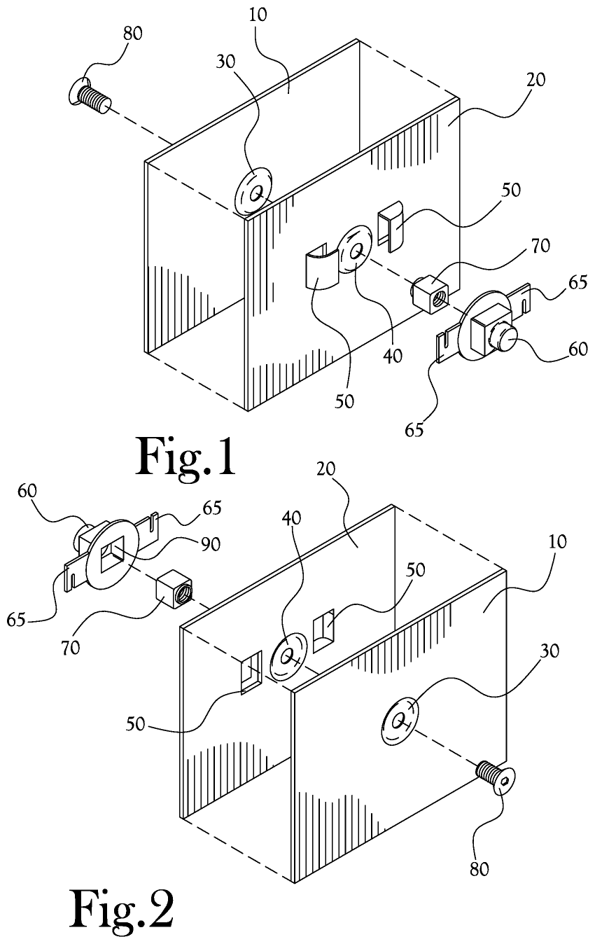

FIG. 1 illustrates a bolt and nut retainer assembly according to an example embodiment of the present general inventive concept. It is understood that while most of the descriptions herein describe a pool step assembly, the bolt and nut retainer assembly could be used to attach a plurality of different types of components together. In FIG. 1, an upper layer 10 simply refers to a portion of a pool step assembly that will be located exterior to a lower layer 20. In other words, when a host of step assembly components are assembled to form steps, overlapping portions will be coupled together with the bolt and nut retainer assembly or system described herein, with the upper layer 10 referring to the overlapping portion that will be above or outside of the steps, and the lower layer 20 that will be below or inside of the steps. Such portions may be entire panels, small connecting portions, lips extending from panels, etc. Different components of the pool step assembly may have both upper layer 10 portions and lower layer 20 portions that are respectively fitted together with adjacent components. As such, the different pool step components may be fitted together and secured in place with a relatively smooth or continuous outer appearance, the nut retainer discussed herein being hidden beneath the surface of the steps or other such types of assemblies.

In the example embodiment illustrated in FIG. 1, the upper layer 10 includes a first countersink bolt hole 30, and the lower layer 20 includes a corresponding countersink bolt hole 40 that is formed to align with the first countersink bolt hole 30. The countersink bolt holes 30,40 are configured to receive a bolt 80 that will be used to fix the upper and lower layers 10,20 to one another. It is understood that this example embodiment includes the countersink bolt holes 30,40 to provide a substantially flush fit of the bolt 80 head and the outer surface of the pool steps, as well as to help guide the bolt holes 30,40 together, but various other example embodiments may not employ such a countersink. As illustrated in FIG. 1, a pair of slots 50 have been formed in the lower layer 20 at opposite sides of the countersink bolt hole 40 to respectively receive a pair of wings 65 that extend from opposite sides of a nut retainer 60. As illustrated, the slots 50 may be formed as raised sections of the lower layer 20, and may be punched into formation during the fabrication of the lower layer 20. The nut retainer 60 is configured to receive a nut 70 and hold it in place, so that a user can place the nut 70 in the nut retainer 60 and attach the nut retainer 60 to the lower layer 20 before overlapping the upper layer 10 and lower layer 20. Thus, the user can then simply line up the countersink bolt holes 30,40 and screw the bolt 80 in to attach the two layers without having to access the underside of the layers. FIG. 2 illustrates a different view of the example embodiment illustrated in FIG. 1. As illustrated in FIG. 2, the nut retainer 60 is provided with a nut receiving portion 90 that is squared to prevent the square nut 70 from rotating, and is also closed at a back portion thereof to hold the nut 70 in place against the back surface of the lower layer 20. Although this example embodiment is illustrated with a four-sided nut and corresponding four-walled nut receiving portion, various example embodiments may have a host of different configurations to prevent the nut 70 from rotating inside the nut receiving portion 90 of the nut retainer 60. The slots 50 have openings that face one another, and each slot 50 also has one open side and one closed side to allow the nut retainer 60 to be rotated and essentially locked into place at most any orientation. Thus, the wings 65 of the nut retainer 60 are received in the corresponding slots 50 to create a “twist lock” attachment feature of the nut retainer 60. When so affixed, the nut retainer 60 is substantially prevented from lateral movement over the lower layer 20, as well as movement toward and away from the lower layer 20. Different example embodiments of the present general inventive concept may include different numbers of wings and corresponding slots. Also, as previously noted, different example embodiments may include different nut and nut receiving portion configurations other than the square configuration illustrated in FIGS. 1-2, so long as the nut is prevented from rotating.

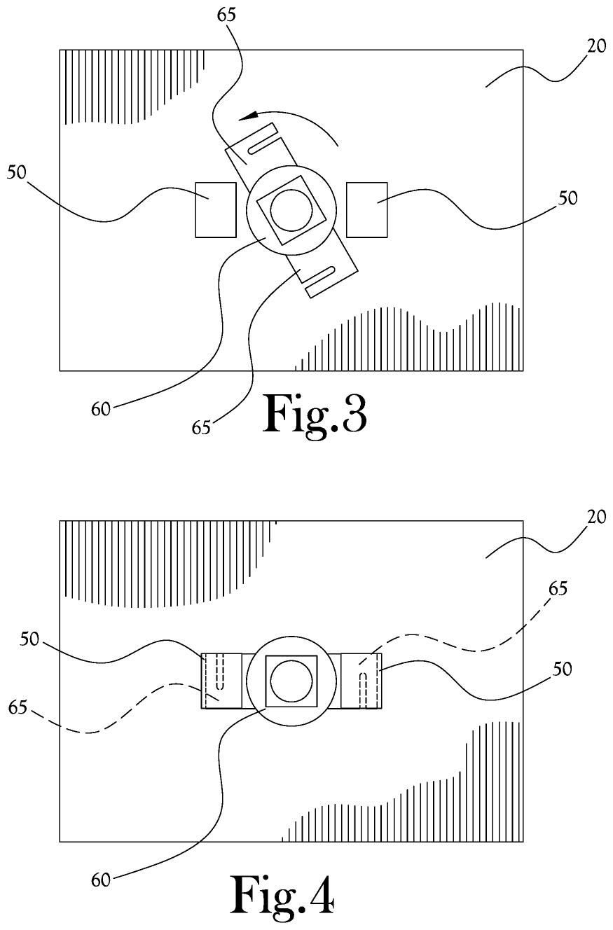

FIG. 3 illustrates an installation of the nut retainer 60 illustrated in FIG. 1, and FIG. 4 illustrates the nut retainer of FIG. 1 in an installed position. As illustrated in FIG. 3, after a user has placed the nut 70 inside the nut retainer 60, the user then simply places the nut retainer 60 against the countersink bolt hold 40 of the lower layer 20 and rotates the nut retainer 60 into place to be secured by the slots 50. As illustrated in FIG. 4, the nut retainer 60 is now secured in place, and the bolt 80 can be moved through the corresponding countersink bolt holes 30,40 and into the nut 70 to fix the upper layer 10 to the lower layer 20. When the nut retainer 60 is secured in place as illustrated in FIG. 4, the structure of the slots 50 formed on the back surface of the lower layer 20 secure the wings 65 of the nut retainer 60 in place to prevent the nut retainer from moving laterally from, or away from, the second countersink bolt hole 40. In various example embodiments the slots 50 may be formed so as to provide a friction fit for the wings 65 to provide a secure hold on the nut retainer 60. Similarly, the nut receiving portion 90 of the nut retainer may be formed to provide a friction fit for the nut 70 to prevent the nut 70 from falling out of the nut retainer 60 while the nut retainer 60 is moved into place.

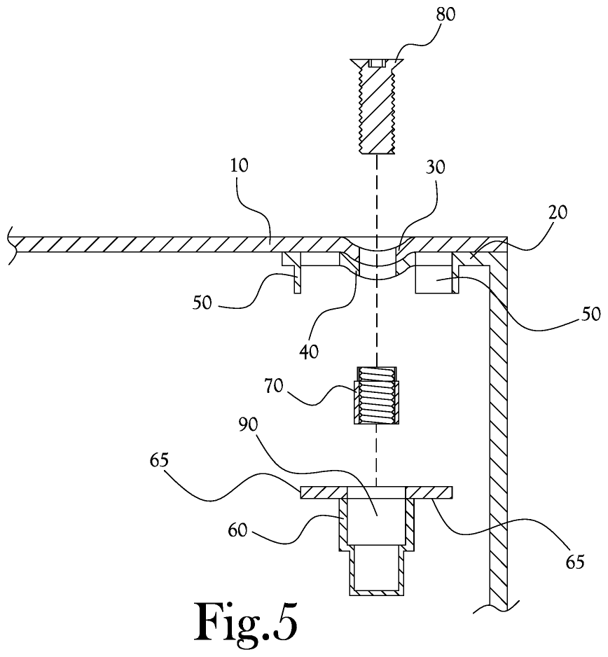

FIG. 5 illustrates an exploded cross-sectional view of components of the nut retainer assembly and two overlapping layers of the pool step assembly. In this illustrated example, the upper layer 10 may be a top portion of a step of a step assembly, and the lower layer 20 may be an adjacent portion of the step assembly between top surfaces of adjacent steps. With the nut retainer 60 secured in place underneath the lower layer 20 by manipulating the wings 65 of the nut retainer into the slots 50 formed on the lower surface of the lower layer 20, the user can easily attach the top layer 10 to the bottom layer 20 without having to be able to reach the nut 70, greatly simplifying the construction of the step assembly. Thus, in a method of assembling the layers of the pool assembly, the user may place the nut 70 inside the nut receiving portion 90 of the nut retainer 60. The user then manipulates the nut retainer 60 so that the wings 65 of the nut retainer 60 are fitted inside the slots 50, such as by twisting the nut retainer 60 by placing the nut retainer over the hole with the wings 65 pointing away from the slots 50, and then twisting the nut retainer 60 in a direction to move the wings 65 into the slots 50 until they abut the close surface of the slots 50, effectively “locking” the nut retainer 60 into place. With such a secure configuration, the user may then place the upper layer 10 over the lower layer 20 with the first and second countersink bolt holes 30,40 aligned to receive the bolt 80. Since the nut retainer 60 is held in place by the interaction of the wings 65 and slots 50, and therefore, the nut 70 is held in proper place relative the second countersink bolt hole 40, the user does not need access or even sight of the nut 70 in order to thread the bolt 80 through the first and second countersink bolt holes 30,40 to secure the upper layer 10 to the lower layer 20.

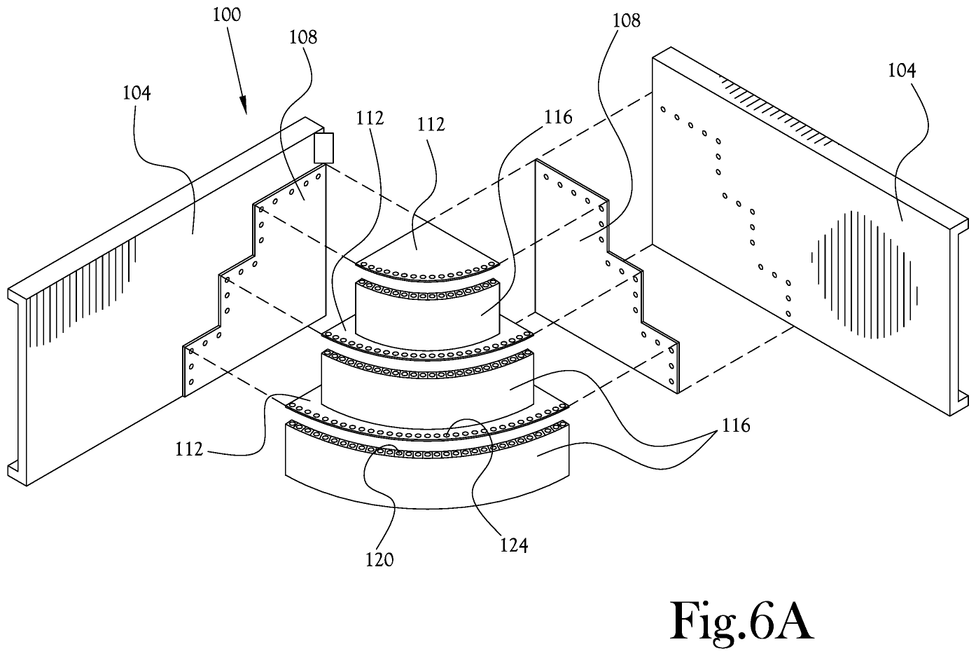

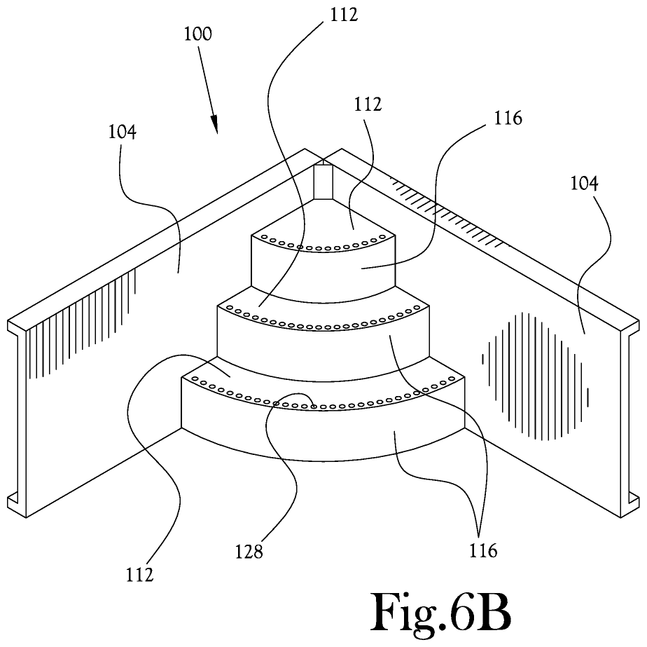

FIGS. 6A-B respectively illustrate exploded and assembled views of a pool step assembly according to an example embodiment of the present general inventive concept. As illustrated in FIG. 6A, the pool step assembly 100 includes two wall portions 104 to which two respective side portions 108 will be attached to provide structural support for the step portions 112 and riser portions 116 which will form the steps of the step assembly 100. It is understood that a host of different configurations may be used without departing from the scope of the present general inventive concept. Each of the riser portions 116 has a lip portion that folds over and inward to lie between a corresponding outer edge of the step portions 116. The lip portions have a plurality of second countersink bolt holes 120 that correspond to a respective plurality of first countersink bolt holes 124 provided at the outer edges of the step portions 116. There are similar lip portions provided at side edges of both the step portions 112 and riser portions 116 to match corresponding through holes in the side portions 108. In this example embodiment, the side portions 108 will be sandwiched between the respective step and riser portions 112,116 and the wall portions 104. At places where a nut will be provided, such as below second countersink bolt holes 120 of the riser portion 116 lips, and behind the countersink bolt holes of the wall portions 104, slots will be formed to hold the nut retainer so as to secure a nut in place behind the second countersink bolt holes 120. Thus, a single user can easily assemble the step assembly 100 one component at a time, such as by securing a plurality of nut retainers under the lip of the bottommost riser portion 116, and then laying the bottommost step portion 112 over that lip and securing the step portion 112 to the riser portion 116. Similarly, the nut retainers can be placed behind the wall portions 104 to secure the riser and step portions 116,112 to the wall portions 104 with the side portions 108 therebetween. The assembled state of the step assembly 100 is illustrated in FIG. 6A, and bolts 128 have been placed through the bolt holes to secure the assembly together. At that point, the pool liner can be placed over the step assembly 100. Thus, the various components of the step assembly 100 may all be fixed to one another using the nut retainer assembly as described herein, which affords the user the benefit of assembling the steps in place in a convenient and easy manner, and having an easily formed flush surface under an added pool liner.

Various example embodiments of the present general inventive concept may provide a nut retaining device including a nut retainer body configured to receive a nut at least partially therein, and at least one extending member extending laterally away from a longitudinal axis of the nut retainer body and configured to abut a surface to prevent movement of the nut retainer body in at least one direction. The at least one extending member may include a plurality of wings extending laterally from the nut retainer body and configured to abut one or more surfaces to prevent lateral and rotational movement of the nut retainer body. The plurality of wings may include two flat wings extending in substantially opposite directions from one another. The nut retainer body may be configured prevent the nut from rotating inside the nut retainer body. The nut retainer body may be formed with a nut receiving portion having a plurality of flat sides to prevent the nut from rotating inside the nut retainer body. The nut retainer body may be formed with a plurality of flat gripping portions on a back side.

Various example embodiments of the present general inventive concept may provide a nut retaining device including a nut retainer body configured to receive a nut and prevent the nut from rotating inside the nut retainer body. and a plurality of wings extending laterally from the nut retainer body and configured to abut one or more surfaces to prevent movement of the nut retainer body.

Various example embodiments of the present general inventive concept may provide a pool step system including a plurality of step members configured to have overlapping portions when assembled into steps, the overlapping portions including a plurality of upper layers and lower layers to be respectively fixed to one another, corresponding through holes formed in the upper layers and lower layers to receive a bolt to fix the upper and lower layers to one another, a plurality of raised slots formed on an underside of the lower layers proximate each of the through holes of the lower layers, a plurality of nut retaining devices each including a nut retainer body configured to receive a nut and prevent the nut from rotating inside the nut retainer body, a plurality of nuts respectively provided to the nut retaining devices, and a plurality of wings extending laterally from the nut retainer body and configured to be received in the raised slots to prevent movement of the nut retainer body, and a plurality of bolts configured to extend through the respective corresponding through holes and into the respective nuts to fix the upper and lower layers to one another. The through holes may be formed as countersinks. An inner surface of the nut retainer body that contacts the nut may be configured as a polygon. The raised slots may be integral portions of the lower layers. The raised slots may be closes at a top and at least one side thereof. The raised slots may be formed to provide a friction fit to the wings of the nut retaining devices.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A nut retaining device, comprising:
a nut retainer body configured to receive a nut at least partially therein; and
at least one extending member extending laterally away from a longitudinal axis of the nut retainer body and configured to abut a surface to prevent movement of the nut retainer body in at least one direction.

2. The nut retaining device of claim 1, wherein the at least one extending member comprises a plurality of wings extending laterally from the nut retainer body and configured to abut one or more surfaces to prevent lateral and rotational movement of the nut retainer body.

3. The nut retaining device of claim 2, wherein the plurality of wings comprises two flat wings extending in substantially opposite directions from one another.

4. The nut retaining device of claim 1, wherein the nut retainer body is configured prevent the nut from rotating inside the nut retainer body.

5. The nut retaining device of claim 4, wherein the nut retainer body is formed with a nut receiving portion having a plurality of flat sides to prevent the nut from rotating inside the nut retainer body.

6. The nut retaining device of claim 5, wherein the nut retainer body is formed with a plurality of flat gripping portions on a back side.

7. A pool step system, comprising:
a plurality of step members configured to have overlapping portions when assembled into steps, the overlapping portions including a plurality of upper layers and lower layers to be respectively fixed to one another;
corresponding through holes formed in the upper layers and lower layers to receive a bolt to fix the upper and lower layers to one another;
a plurality of raised slots formed on an underside of the lower layers proximate each of the through holes of the lower layers;
a plurality of nut retaining devices each comprising:
a nut retainer body configured to receive a nut and prevent the nut from rotating inside the nut retainer body,
a plurality of nuts respectively provided to the nut retaining devices, and
a plurality of wings extending laterally from the nut retainer body and configured to be received in the raised slots to prevent movement of the nut retainer body; and
a plurality of bolts configured to extend through the respective corresponding through holes and into the respective nuts to fix the upper and lower layers to one another.

8. The system of claim 7, wherein the through holes are formed as countersinks.

9. The system of claim 7, wherein an inner surface of the nut retainer body that contacts the nut is configured as a polygon.

10. The system of claim 7, wherein the raised slots are integral portions of the lower layers.

11. The system of claim 7, wherein the raised slots are closed at a top and at least one side thereof.

12. The system of claim 7, wherein the raised slots are formed to provide a friction fit to the wings of the nut retaining devices.
